(19) United States
(12) Patent Application Publication
(10) Pub. No.: US 2016/0005098 A1
(43) Pub. Date: Jan. 7, 2016

(54) PRODUCT RECOMMENDATION ENGINE BASED ON REMAINING BALANCE IN A STORED-VALUE SCENARIO

(71) Applicant: International Business Machines Corporation, Armonk, NY (US)

(72) Inventors: Sean P. Flynn, Lowell, MA (US); Caitlin R. Gilman, Lowell, MA (US); Yi H. Lo, Lunenburg, MA (US); Ting Fai S. Wong, Lowell, MA (US)

(21) Appl. No.: 14/644,571

(22) Filed: Mar. 11, 2015

Related U.S. Application Data
(63) Continuation of application No. 14/323,303, filed on Jul. 3, 2014.

(51) Int. Cl. G06Q 30/06; G06Q 20/34

(52) U.S. Cl. CPC G06Q 30/0631; G06Q 20/342

(57) ABSTRACT

According to embodiments of the present invention, computer-implemented methods, systems, and computer program products are provided, which identify items based on a redeemable balance. A remaining redeemable balance for a user based on a cost of one or more selected items is determined. One or more items of interest are identified to the user based on at least a cost of each item of interest in relation to the remaining redeemable balance. The identified one or more items of interest are ranked based on a sum of the cost of the identified one or more items of interest to the remaining redeemable balance. Electronic purchase of the identified one or more items of interest are enabled via the remaining redeemable balance.

### CROSS-REFERENCE TO RELATED APPLICATIONS

This application is a continuation of U.S. patent application Ser. No. 14/323,303, entitled “PRODUCT RECOMMENDATION ENGINE BASED ON REMAINING BALANCE IN A STORED-VALUE SCENARIO” and filed Jul. 3, 2014, the disclosure of which is incorporated herein by reference in its entirety.

### BACKGROUND

Present invention embodiments relate to managing balances in stored-value scenarios, and more specifically, to managing unspent balances for products such as consumer gift cards.

Gift cards purchased by consumers typically are purchased in value amounts, e.g., $10, $25, $50, etc. Consumer purchases rarely add up to the exact amount of the gift card. Accordingly, after making a purchase with a gift card, consumers frequently have a remaining unspent balance. The gift card could go unused and eventually expire, without the consumer being able to regain or utilize the remaining unspent balance on the gift card.

### SUMMARY

According to embodiments of the present invention, a computer-implemented method, system, apparatus and computer readable memory are provided, which identify items based on a redeemable balance. A remaining redeemable balance for a user based on a cost of one or more selected items is determined. One or more items of interest are identified to the user based on at least a cost of each item of interest in relation to the remaining redeemable balance. The identified one or more items of interest are ranked based on a sum of the cost of the identified one or more items of interest to the remaining redeemable balance. Electronic purchase of the identified one or more items of interest are enabled via the remaining redeemable balance.

These and other aspects, features and advantages of the present invention will be understood with reference to the drawing figures, and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE SEVERAL VIEWS OF THE DRAWINGS

Generally, like reference numerals in the various figures are utilized to designate like components.

FIG. 1 is a block diagram showing an example computing environment for a recommendation engine in accordance with an embodiment of the present invention.

FIG. 2 is a procedural flow chart of generating a product recommendation based on a remaining redeemable balance in accordance with an embodiment of the present invention.

FIG. 3A is an example illustration of a data set including products, associated cost, and frequency of purchase in accordance with an embodiment of the present invention.

FIG. 3B is an example illustration of product recommendations based upon both remaining balance and frequency of purchase in accordance with an embodiment of the present invention.

FIG. 4 is a more general procedural flow chart of product recommendations based upon a remaining redeemable balance in accordance with an embodiment of the present invention.

FIG. 5 is an example block diagram of an apparatus capable of making a product recommendation in accordance with an embodiment of the present invention.

### DETAILED DESCRIPTION

According to embodiments of the present invention, computer-implemented methods, systems, and computer program products are provided, which identify items based on a remaining redeemable balance. A remaining redeemable balance for a user based on a cost of one or more selected items is determined. One or more items of interest are identified to the user based on at least a cost of each item of interest in relation to the remaining redeemable balance. The identified one or more items of interest are ranked based on a sum of the cost of the identified one or more items of interest to the remaining redeemable balance. Electronic purchase of the identified one or more items of interest are enabled via the remaining redeemable balance.

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others. The techniques presented herein are not to be limited to the example embodiments set forth herein.

Recommendation engines may recommend items that are well above the remaining redeemable balance of the consumer gift card, as such engines do not consider the remaining redeemable balance, which ultimately may deter a consumer from making a recommended purchase. While these types of item recommendations may provide a rough estimate of items that the customer may be interested in purchasing, these recommendations do not take into account the remaining balance of the gift card. Accordingly, a customer may choose not to spend the remaining balance on the gift card, because finding available products that fit within the remaining balance becomes a time consuming or difficult manual process. Additionally, if the remaining balance is small, it may be difficult to identify items of lower cost.

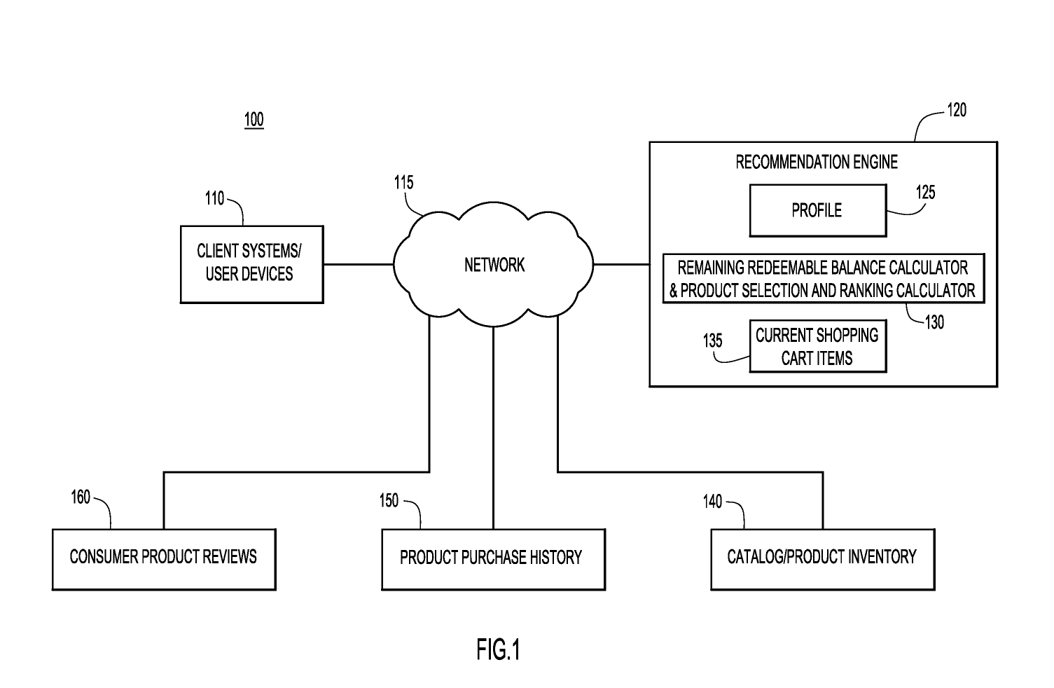

With reference now to FIG. 1, an example environment for use with present invention embodiments is illustrated in FIG. 1. Specifically, the environment 100 includes one or more client systems/user devices 110, a network 115, a recommendation engine 120, and one or more sources of information which may serve as input to recommendation engine 120, such as product inventory 140, product purchase history 150, and consumer product reviews 160. These sources of information may be stored remotely in a separate database, assessable via any suitable network connection, or may be stored locally with regard to the recommendation engine 120.

Client systems 110 and recommendation engine 120 may be remote from each other and communicate over a network 115. The network may be implemented by any number of any suitable communications media (e.g., wide area network (WAN), local area network (LAN), Internet, Intranet, etc.). Alternatively, client systems 110 and recommendation engine 120 may be local to each other, and communicate via any appropriate local communication medium (e.g., local area network (LAN), hardwire, wireless link, Intranet, etc.).

Current shopping cart items 135 may contain information about the products/items added to a shopping cart, quantity of each item, as well as an associated cost of each item. The cost of each item in the shopping cart may be summed to obtain a total cost, and the total cost may be utilized to determine a remaining redeemable balance of a gift card and products that may be purchased based upon the remaining redeemable balance.

Consumer product reviews 160 may contain information regarding quality of a particular product. Highly rated products may be ranked higher by the recommendation engine as compared to products that received a poorer rating by consumers.

Product purchase history 150 may contain information regarding how frequently a particular product was purchased, e.g., by an individual or by a group of individuals. Products which were purchased more frequently may be ranked higher by the recommendation engine as compared to products that were purchased less frequently. In other embodiments, product purchase history 150 may contain information regarding the likelihood of another item being selected based upon a currently selected item found in current shopping cart 135.

Product inventory 140 may include information regarding availability of products or items which may be purchased with a gift card or other stored value type scenario.

Client systems 110 allow users to select items for purchase (e.g., items from an online store catalog, etc.) and to send the selected item(s) to recommendation engine 120. Recommendation engine 120 may comprise various modules including a profile 125, a remaining redeemable balance calculator and product selection and ranking calculator 130 and current shopping cart items 135. Profile 125 may store information pertaining to, e.g., an individual's or a group's product purchase history, preferences, consumer product reviews, popularity, etc. Balance and selection calculator 130 may determine remaining redeemable balances by considering the cost of an item that has been added to a shopping cart. The recommendation engine 120, utilizing information provided by the balance and selection calculator 130 in relation to remaining redeemable balances, may suggest additional items for purchase based upon information found in one or more of profile 125, product inventory 140, currently selected shopping cart items 135, product purchase history 150, and consumer product reviews 160. Balance and selection calculator 130 may store information regarding the monetary balance of a gift card, e.g., the available or remaining balance on a particular gift card, etc. Additionally, balance and selection calculator 130 may identify and recommend products for purchase to a user, with the results provided in ranked order.

In other embodiments, recommendations may be made without creating a profile to store information. In such cases, the recommendation engine 120 accesses one or more types of information found in modules 140-160 directly and utilizes this information to make product recommendations.

In some embodiments, a database system may store various types of information (e.g., consumer product reviews 160, product purchase history 150, profile 125, product inventory 140, shopping cart 135, etc.) for this analysis. The database system may be implemented by any conventional or other database or storage unit, may be local to or remote from recommendation engine 120 and client systems 110, and may communicate via any appropriate communication medium (e.g., local area network (LAN), wide area network (WAN), Internet, hardwire, wireless link, Intranet, etc.).

The client systems may present a graphical user (e.g., GUI, etc.) or other interface (e.g., command line prompts, menu screens, etc.) to solicit information from users pertaining to the desired items and analysis, and may provide information including recommended results (e.g., recommended items, etc.) to a user.

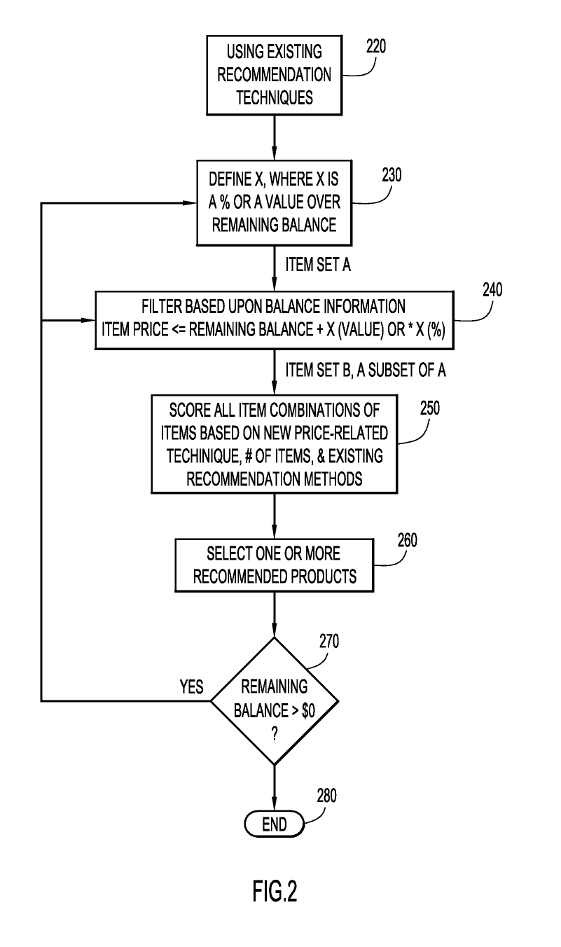

Referring to FIG. 2, an example flow chart is provided, showing how product recommendations may be made by recommendation engine 120 based on a remaining redeemable balance on a gift card. Combinations of one or more related items/items of interest whose total cost falls within the remaining balance or cost range may be generated. A ranking for each combination of the one or more related items is also generated. A combination may comprise a single item or a multitude of items. Recommendations may be made after current cart purchases have been applied (or may be based upon items in a shopping cart) against the remaining redeemable balance of the stored value card (e.g., gift card, user store credit, etc.) and may take into account information associated with previous purchases, customer reviews, etc., as well as other information associated with recommendation techniques.

At 220, existing recommendation techniques may be supplied as input to recommendation engine 120. For example, an item for purchase having an associated cost may be selected at 220 according to existing recommendation techniques, and this information may be provided as input into the recommendation engine. The remaining redeemable balance is the difference between the value of the gift card and the value of the selected item at 220. At 230, ‘X’ is defined, where ‘X’ is a percentage or value over/above a remaining balance. ‘X’ may represent a percentage or a specified value that a customer is willing to spend in addition to the remaining balance on the gift card. In some embodiments, the total amount or total balance, which is the redeemable amount plus ‘X’, may be used by the recommendation engine instead of the remaining redeemable balance on the gift card.

Item set A may represent a set of items available for selection by a user. At 240, filtering may be performed, in which item set A is narrowed to item set B, e.g., by excluding or filtering out items having costs that are greater than a specified price/balance. Items equal to or less than the remaining redeemable balance of the gift card or items less than or equal to the total balance, e.g., redeemable amount plus ‘X’, may be used to select a subset of A (item set B).

At 250, one or more items are scored and ranked based upon a variety of factors including one or more of information from profile 125, consumer product reviews/popularity 160, product purchase history 150, product inventory 140, current shopping cart items 135, etc. The recommendation engine 120 may make recommendations that are likely to be of interest based on selected items in a user's current shopping cart, past purchases, other customer purchases, etc., and may utilize the remaining redeemable balance on a gift card, stored value card, credit, etc.

At 260, a customer may select one or more recommended items. A single item may be selected, or a combination of multiple items may be selected, provided that the cost of the combination of multiple items falls below the remaining redeemable balance.

At 270, the recommendation engine 120 updates the remaining balance to reflect items added to the cart or purchased. If a balance remains on the gift card, the process may repeat at 230 or 240, until the remaining balance on the gift card has been consumed. Each time an item is added to the shopping cart, the recommended products returned by the recommendation engine 120 may be updated as well. Once the remaining balance has been consumed, the process terminates at 280.

The example embodiments of the present invention as described herein provide a number of advantages including, without limitation, minimizing wasted value on gift cards, enhancing sales revenue, and providing a better customer experience. Present invention embodiments include but are not limited to online purchasing, point of sale, call centers, reward programs (e.g., airline, hotel, rental, product, credit card, etc.), exchange items, promotional recommendations, etc. Present invention embodiments are not limited to gift cards and may include other types of pre-purchased or determined amounts including store value cards, store credit, etc.

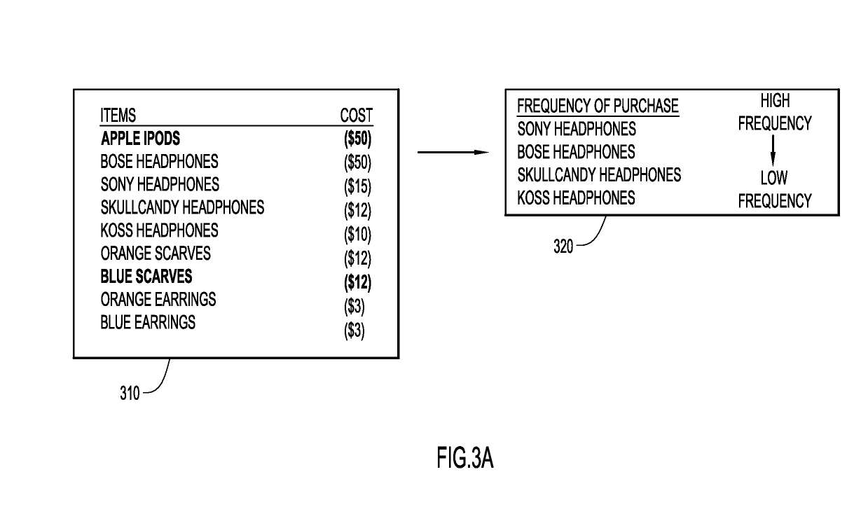

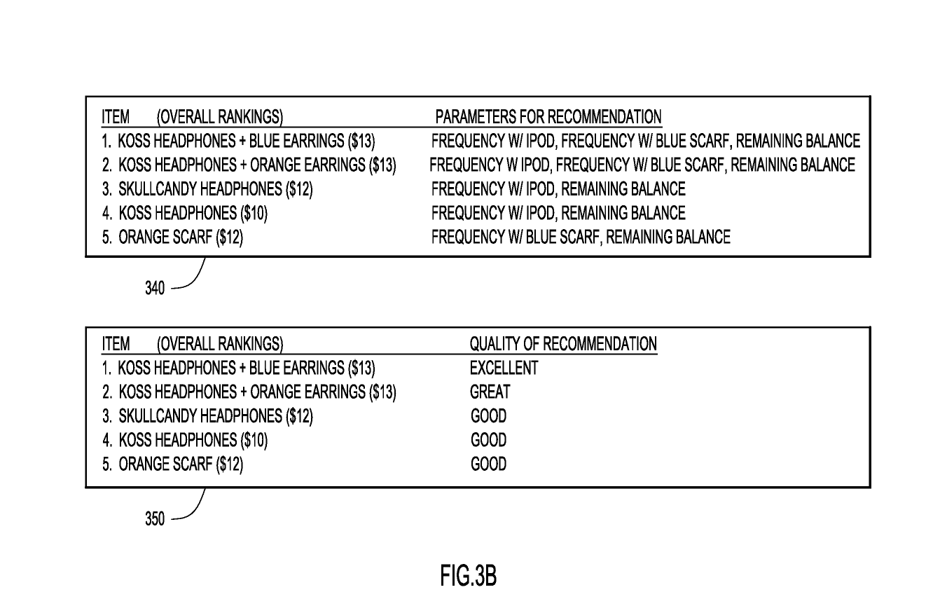

Referring to FIG. 3A, an example is depicted of a data set including products, associated cost, and frequency of purchase in accordance with an embodiment of the present invention. Frequency information may not only comprise the number of times that a selected item has been purchased, as shown in FIG. 3A, but also, the number of times that a selected item has been purchased in combination with other items. For example, if Sony headphones are selected, information may be provided to the recommendation engine 120 regarding the frequency of purchase of other products/items of interest along with Sony headphones, e.g., users who bought Sony headphones frequently also purchased orange earrings. This information may be provided as input to recommendation engine 120 and factored into product recommendations and rankings. For example, the one or more items of interest may be ranked based on a sum of the cost of the identified one or more items of interest to the remaining redeemable balance and the frequency of purchase of the particular item or combination of items with respect to the selected item. An online store, “BuyNow”, sells a variety of items, shown at 310. An online customer has a $75 gift card to “BuyNow”. The customer adds an Apple iPod for $50 and blue scarves for $12 in her shopping cart 135, totaling $62. If only the products currently in the shopping cart are purchased, a remaining balance of $13 would remain on the gift card.

Based on product purchase history 150, which includes purchases by a variety of customers, the recommendation engine 120 establishes that users/customers who buy Apple iPods most frequently buy the headphone brands, shown in descending order (most frequent to least frequent), at 320. Thus, items of interest may be identified based on a relationship to the selected item.

For the purpose of this example, sales tax and shipping costs are ignored. However, it is expressly understood that the embodiments disclosed herein encompass such features.

Several of the items are higher or lower than the redeemable balance of the gift card. For instance, the items Sony Headphones valued at $15 and Bose Headphones valued at $50 exceed or greatly exceed the remaining balance of the gift card, while other items, such as blue earrings valued at $3, may cost far less than the remaining balance on the gift card.

According to present invention embodiments, recommendation engine 120, which considers the remaining redeemable balance on the gift card, would recommend the following items (in order of most recommended to least recommended), as shown in FIG. 3B at 340, which fall within a range of or below the remaining redeemable balance of $13. (The range of the remaining redeemable balance may also be specified as a percentage of the remaining redeemable balance.) Recommended items are shown in the column entitled “Item”, while parameters determining the ranking of each item are shown in the column entitled “Parameters for Recommendation”.

It is noted that the “overall rankings” as shown at 340 may be based upon both a cost factor and a relational ranking factor for combinations of products. Overall ranking is a composite of “price ranking”, which is generated from factors comprising at least the difference between the sum of the items of interest in the combination and the remaining redeemable balance, and the “relation ranking”, which is generated from factors comprising at least one of the purchase history, frequency of purchase of the item of interest with regard to the selected product, etc. Thus, a combination with a higher price ranking may not always have a higher overall ranking, once relational ranking factors are considered.

FIG. 3B at 340 provides an example of a product with a higher price ranking, having an overall ranking that is lower than a product with a better price ranking. For example, the KOSS headphones ($10) are ranked higher than the orange scarf ($12) despite the orange scarf using more of the remaining balance and therefore having a higher price ranking. This is because the KOSS headphones have a stronger relation ranking in comparison with the orange scarf. The orange scarf is less frequently purchased with the blue scarf (currently selected) than the KOSS headphones with the iPod (also currently selected). Without the overall ranking determined as a composite of price ranking and relation ranking, this type of improved recommendation would not have been reached.

These item recommendations take into account the remaining balance of the gift card, and provide more appropriate suggestions as to items that the consumer may want to purchase. The remaining redeemable balance on the gift card is factored into the existing frequency data to augment and improve recommendations. Other considerations, e.g., products reviews, etc., may be factored into the recommendations as well.

Additionally, multiple items may be recommended by the recommendation engine 120. For example, line 1 shows that the recommendation engine has considered both the frequency of each recommended item as well as the remaining balance when recommending KOSS headphones+blue earrings for a combined total of $13.

For each recommendation, the quality of recommendation may be assessed, as shown at 350. The quality of the recommendation may be based upon minimizing the redeemable balance on the gift card, as well as other criteria such as customer reviews and frequency of purchase, etc.

It is also noted that if the customer were to specify to the recommendation engine that the total amount/remaining balance to spend is $15 (e.g., the remaining balance on the gift card plus a value of $3) the recommendation engine would return a suggestion of Sony Headphones for $15.

Thus, specifying an additional amount or value that the user is willing to spend, and adding the value to the remaining redeemable balance to establish a total balance allows a user to quickly identify items of interest within a specified budget. Thus, one or more items of interest to the user may be identified based on at least a cost of each item of interest in relation to the total balance. The identified one or more items of interest may be ranked based on the cost relation of the identified items of interest to the total balance. Electronic purchase of the identified one or more items of interest are enabled via the total balance.

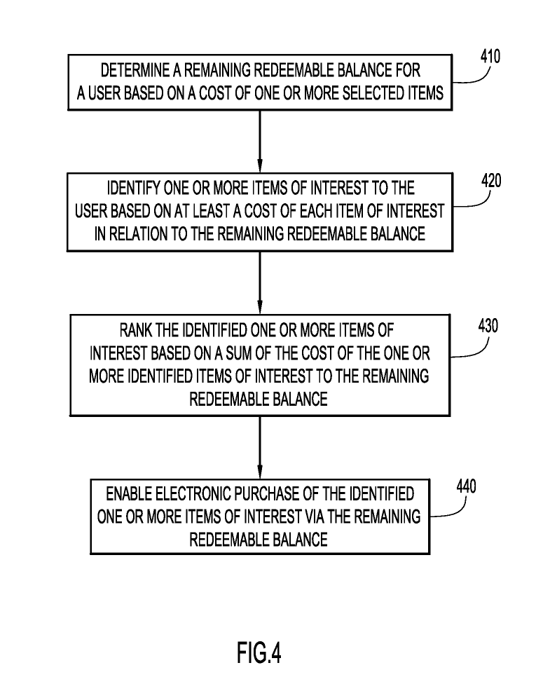

FIG. 4 shows a general flow diagram according to present invention embodiments. At 410, a remaining redeemable balance for a user based on a cost of one or more selected items is determined. At 420, one or more items of interest to the user based on at least a cost of each item of interest in relation to the remaining redeemable balance is identified. At 430, the identified one or more items of interest are ranked based on a sum of the cost of the identified one or more items of interest to the remaining redeemable balance. At 440, electronic purchase of the identified one or more items of interest via the remaining redeemable balance is enabled.

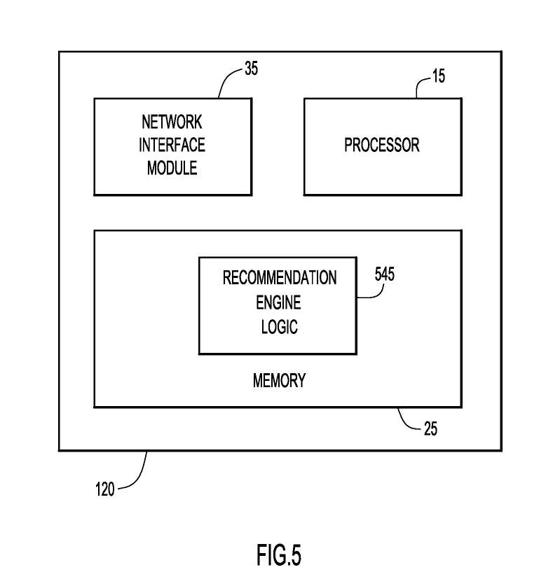

FIG. 5 illustrates an example block diagram of recommendation engine 120, configured to perform the techniques presented herein. Recommendation engine 120 may include a network interface unit 35, a processor 15, and a memory 25. The network interface unit 35 is configured to enable network communications over network 115 to send information to module 110 regarding making product recommendations as shown in FIG. 1.

The processor 15 may be embodied by one or more microprocessors or microcontrollers, and executes computer readable program instructions stored in memory 25 for recommendation logic 545 to perform the operations described above in connection with FIGS. 1-4. Product recommendation engine logic 545 may utilize information in one or more of profile 125, shopping cart 135, product inventory 140, purchase history 150, and product reviews 160 as well as utilize balance and selection calculator 130 to provide product recommendations and rankings.

Memory 25 may be embodied by one or more computer readable storage media that may comprise e.g., read-only memory (ROM), static random access memory (SRAM), magnetic disk storage media devices, optical storage media devices, flash memory devices, electrical, optical, or other physical/tangible memory storage devices.

Thus, in general, the memory 25 may comprise one or more tangible (i.e., non-transitory) computer readable storage media (e.g., a memory device) encoded with software comprising computer readable program instructions, and when the software is executed by the processor 15, the processor 15 is operable to perform the operations described herein in connection with recommendation logic 545.

Recommendation engine 120 and client systems 110 may be implemented by any conventional or other computer systems preferably equipped with a display or monitor, a base (e.g., including at least one processor 15, one or more memories 25 and/or internal or external network interfaces or communications devices 35 (e.g., modem, network cards, etc.)), optional input devices (e.g., a keyboard, mouse or other input device), and any commercially available and custom software (e.g., server/communications software, module, browser/interface software, etc.).

Alternatively, one or more client systems 110 may make recommendations of items falling within a range of a remaining redeemable balance, when operating as a stand-alone unit. In a stand-alone mode of operation, the client system 110 stores or has access to data (e.g., profile 125, product inventory 140, product purchase history 150, consumer product reviews 160, current shopping cart items 135, etc.) needed for analysis, and may include modules, e.g., balance and selection calculator 130, recommendation engine 120, etc., to perform necessary computations. The graphical user (e.g., GUI, etc.) or other interface (e.g., command line prompts, menu screens, etc.) solicits information from a corresponding user pertaining to the desired items and analysis, and may provide information including analysis results.

A module may include one or more modules or units to perform the various functions of present invention embodiments described herein. The various modules (e.g., recommendation engine 120, etc.) may be implemented by any combination of any quantity of software and/or hardware modules or units, and may reside within memory 25 of the server and/or client systems for execution by processor 15.

It will be appreciated that the embodiments described above and illustrated in the drawings represent only a few of the many ways of implementing embodiments for making product recommendations based upon a remaining balance or specified total balance.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, profile generation module, etc.). These systems may include any types of monitors and input devices (e.g., keyboard, mouse, voice recognition, etc.) to enter and/or view information.

It is to be understood that the software (e.g., recommendation engine) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., recommendation engine) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., profile information, current shopping cart items, consumer product reviews, product purchase history, product inventory, product recommendations, etc.). The database system may be implemented by any number of any conventional or other databases, data stores or storage structures (e.g., files, databases, data structures, data or other repositories, etc.) to store information (e.g., profile information 125, current shopping cart items 135, consumer product reviews 160, product purchase history 150, product inventory 140, product selections/recommendations 130, etc.). The database system may be included within or coupled to the server and/or client systems. The database systems and/or storage structures may be remote from or local to the computer or other processing systems, and may store any desired data (e.g., profile information 125, current shopping cart items 135, consumer product reviews 160, product purchase history 150, product inventory 140, product selections/recommendations 130, etc.).

The present invention embodiments may employ any number of any type of user interface (e.g., Graphical User Interface (GUI), command-line, prompt, etc.) for obtaining or providing information (e.g., profile information 125, current shopping cart items 135, consumer product reviews 160, product purchase history 150, product inventory 140, product selection/recommendations 130, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The product recommendations may include any information arranged in any fashion, and may be configurable based on rules or other criteria to provide desired information to a user (e.g., product selections/recommendations 130, etc.).

The present invention embodiments are not limited to the specific tasks or algorithms described above, but may be utilized for any task or algorithm in which purchases are determined based upon a determined balance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of identifying items based on a redeemable balance comprising:
determining a remaining redeemable balance for a user based on a cost of one or more selected items;
identifying one or more items of interest to the user based on at least a cost of each item of interest in relation to the remaining redeemable balance;
ranking the identified one or more items of interest based on a sum of the cost of the identified one or more items of interest to the remaining redeemable balance; and
enabling electronic purchase of the identified one or more items of interest via the remaining redeemable balance.

2. The method of claim 1, wherein identifying one or more items of interest includes:
identifying the one or more items of interest further based on at least one of a purchase history and a relationship to the selected items.

3. The method of claim 1, wherein the cost of each of the identified one or more items of interest is less than or equal to the remaining redeemable balance.

4. The method of claim 1, wherein the cost of each of the identified one or more items of interest is within a range of the remaining redeemable balance.

5. The method of claim 4, wherein the range of the remaining redeemable balance is a percentage of the remaining redeemable balance.

6. The method of claim 1, wherein identifying one or more items of interest comprises:
identifying the one or more items of interest based on a purchase history, wherein the purchase history comprises frequency information regarding a number of times that an item of interest or a combination of items of interest have been purchased along with the one or more selected items.

7. The method of claim 1, comprising adding a value specified by the user to the remaining redeemable balance to establish a total balance.

8. The method of claim 7, comprising:
identifying one or more items of interest to the user based on at least a cost of each item of interest in relation to the total balance;
ranking the identified one or more items of interest based on a sum of the cost of each identified item of interest to the total balance; and
enabling electronic purchase of the identified one or more items of interest via the total balance.

9. The method of claim 1, comprising ranking the identified one or more items of interest based on a sum of the cost of the identified one or more items of interest to the remaining redeemable balance and a frequency of purchase regarding a number of times that the item of interest or a combination of items of interest have been purchased along with the one or more selected items.
